(19) United States
(12) Patent Application Publication
(10) Pub. No.: US 2018/0038531 A1
(43) Pub. Date: Feb. 8, 2018

(54) CONNECTING APPARATUS COMPRISING A RETENTION COLLAR

(71) Applicant: Veritas AG, Gelnhausen (DE)

(72) Inventors: Dirk Hattass, Grundau (DE); Artur Kari, Grossostheim (DE); Manual Gerigk, Gelnhausen (DE)

(21) Appl. No.: 15/668,061

(22) Filed: Aug. 3, 2017

(30) Foreign Application Priority Data
Aug. 4, 2016 (DE) 10 2016 114 462.2

(51) Int. Cl. F16L 33/18; F16L 33/20; F16L 37/12

(52) U.S. Cl. CPC F16L 33/18; F16L 37/1235; F16L 33/20; F16L 33/32

(57) ABSTRACT

The present disclosure relates to a connecting apparatus for connecting fluid-conducting lines comprising a first fluid-conducting line having a first connecting section, a second fluid-conducting line having a second connecting section, and a retention collar for fixing the connecting sections together. The second connecting section can be introduced axially into the first connecting section to provide a fluidic connection between the first and second fluid-conducting line. The retention collar has first retaining projections designed to engage into a first locking contour on the outer surface of the first fluid-conducting line. The retention collar has second retaining projections designed to engage into a second locking contour on the outer surface of the second fluid-conducting line. The first retaining projections engage into the first locking contour. The second retaining projections engage into the second locking contour to limit an axial displacement of the first connecting section relative to the second connecting section.

### CROSS-REFERENCE TO RELATED APPLICATIONS

This application claims priority to German patent application No. 10 2016 114 462.2, entitled “Verbindungsvorrichtung mit einer Haltemanschette”, and filed on Aug. 4, 2016 by the Applicant of this application. The entire disclosure of the German application is incorporated herein by reference for all purposes.

### BACKGROUND

The present disclosure relates to a connecting apparatus for connecting fluid-conducting lines which comprises a retention collar. In particular, the present disclosure relates to a connecting apparatus for connecting a first fluid-conducting line, in particular a charge air line, to a second fluid-conducting line, in particular a charge air line, wherein the connecting apparatus comprises a retention collar.

A plurality of fluid-conducting lines can be used in a motor vehicle in the form of hoses, tubes and the like such as, for example, a charge air line for conveying air within a motor vehicle. Air is thereby transported through the charge air line to the combustion engine in order to promote combustion of a fuel mixture. Conventionally used connecting apparatus can be damaged by movement and/or deformation of the fluid-conducting lines during motor vehicle operation.

DE 10 2013 012 369 A1 discloses a coupling assembly for pipelines comprising a locking element.

In this context, the task is that of providing a connecting apparatus for fluid-conducting lines which has a long operating life.

### SUMMARY

This task is solved by the subject matter of the independent claims. Advantageous examples of the disclosure constitute the subject matter of the dependent claims as well as the figures and the description.

According to a first aspect of the disclosure, the task is solved by a connecting apparatus for connecting fluid-conducting lines which comprises a first fluid-conducting line having a first connecting section, a second fluid-conducting line having a second connecting section, wherein the second connecting section can be introduced axially into the first connecting section in order to provide a fluidic connection between the first and the second fluid-conducting line, a retention collar for fixing the connecting sections to one another, wherein the retention collar has first retaining projections designed to engage into a first locking contour on the outer surface of the first fluid-conducting line, and wherein the retention collar has second retaining projections designed to engage into a second locking contour on the outer surface of the second fluid-conducting line, wherein the first retaining projections engage into the first locking contour and wherein the second retaining projections engage into the second locking contour in order to limit an axial displacement of the first connecting section relative to the second connecting section.

Employing the retention collar can prevent the second connecting section from accidentally disengaging from the first connecting section and the fluidic connection between the first fluid-conducting line and the second fluid-conducting line thereby becoming separated.

To this end, the second connecting section of the second fluid-conducting line is displaceably supported axially within the first connecting section of the first fluid-conducting line. This can thereby ensure that upon, for example, vibrations or heating of the fluid-conducting lines during operation, the first and second fluid-conducting line can move axially against each other without resulting in a disconnecting of the fluidic connection between the fluid-conducting lines.

The first and second retaining projections of the retention collar thereby engage into the corresponding first and second locking contour and limit the axial movement of the first connecting section relative to the second connecting section. This thus enables the second connecting section to be displaced to a certain degree relative to the first connecting section. The design of the retention collar however prevents the second connecting section from being able to fully slide out of the first connecting section and thus ensures that the fluidic connection between the first and second fluid-conducting line is not separated.

Compared to conventional line mounts, the retention collar according to the disclosure has the advantage of being simpler to produce and being able to be installed with less effort, thereby enabling a significant cost reduction. In addition, the retention collar can be used with a plurality of different fluid-conducting lines since the stability of the fluidic connection does not depend on the material of the fluid-conducting lines. Furthermore, the retention collar can be individually adapted to the respective fluid-conducting lines with respect to the most diverse parameters, particularly as regards the range of tolerance to the axial displacement, and particularly as regards the material's temperature resistance. A universal applicability of the retention collar in widely diverse piping systems thus results.

In one advantageous example, the connecting sections are displaceably fixed by the retention collar.

Doing so achieves the advantage of, on the one hand, the retention collar ensuring an effective fixing of the connecting sections in order to prevent one of the connecting sections from sliding out. On the other hand, the displaceable fixing of the connecting sections ensures a certain degree of axial play so as to enable compensating for a bending or deforming respectively of the connecting sections.

In one advantageous example, the retention collar is designed as a circumferential retention collar around the first and second fluid-conducting line, wherein the first retaining projections and the second retaining projections are arranged on opposite sides of the retention collar.

This example thereby achieves the advantage of the circumferential retention collar affording uniformly stable fixing of the connecting sections of the fluid-conducting lines. By the first and second retaining projections being arranged on opposite sides of the circumferential retention collar, they can in each case effectively engage into the first locking contour of the first fluid-conducting line and the second locking contour of the second fluid-conducting line and thus prevent the second fluid-conducting line from unintentionally withdrawing out of the first fluid-conducting line.

In one advantageous example, respective first slots are arranged between the first retaining projections and respective second slots are arranged between the second retaining projections, wherein the first retaining projections are in particular arranged at an offset relative to the second retaining projections, and wherein the first slots are in particular arranged at an offset relative to the second slots.

This example thereby achieves the technical advantage of the slots formed between the respective retaining projections being able to ensure a sufficient amount of radial movement when fitting the retention collar. The longest possible slot length can ensure the longest possible mechanical leverage when fitting the retention collar, thus ensuring sufficient stability to the retention collar. The offset arrangement of the first retaining projections in relation to the second retaining projections or respectively the first slots in relation to the second slots can improve the stability of the retention collar.

In one advantageous example, layers of plastic are disposed in the first and second slots, whereby the plastic layers are designed to fluidically seal the slots vis-à-vis an outer surface of the first fluid-conducting line or an outer surface of the second fluid-conducting line, wherein the plastic layers in particular comprise a thermoplastic elastomer (TPE).

This example thereby achieves the technical advantage of the plastic layers being able to ensure a particularly effective fluidic seal between the retention collar and the first/second fluidic line. Doing so enables preventing impurities from outside of the fluidic lines from being able to infiltrate into the connecting region between the first and second fluidic line upon the first connecting section displacing axially relative to the second connecting section. This can thus ensure an effective sealing connection and, in particular, prevent sealing ring damage.

In one advantageous example, the connection between the first retaining projections and the first locking contour and/or the connection between the second retaining projections and the second locking contour is designed as a positive-fit connection, in particular as a latching connection.

This example thereby achieves the technical advantage of the positive connection, in particular latching connection, being able to ensure a particularly effective fixing of the fluidic connection between the first and second fluid-conducting line. This thereby ensures that the first and second retaining projections effectively engage into the respective locking contours so as to limit axial displacement of the first connecting section relative to the second connecting section.

In one advantageous example, the second connecting section, comprises an external circumferential sealing web, wherein the circumferential sealing web is in particular rounded on the side facing the first connecting section, and the second connecting section comprises a further external circumferential sealing web, whereby a circumferential sealing ring the around second connecting section is arranged between the circumferential sealing web and the further circumferential sealing web.

This example thereby achieves the technical advantage of the circumferential sealing web on the outer surface of the second connecting section ensuring that an effective fluid-tight connection can be made between the first fluid-conducting line and the second fluid-conducting line when the second connecting section is inserted into the first connecting section. The rounding of the circumferential sealing web on the side facing the first connecting section enables the second connecting section to tilt relative to the first connecting section, thereby enabling tolerance compensation upon a deformation of the first or second fluid-conducting line. Depending on the specific application, the second fluid-conducting line can be tilted up to 5° to the first fluid-conducting line in both respective directions. This thereby prevents the fluid conveyed through the fluid-conducting lines from leaking out of the fluidic connection upon high pressures and high temperatures.

In one advantageous example, the connecting apparatus further comprises a plastic tube which is drawn over the retention collar connected to the first and second connecting section.

This example thereby achieves the technical advantage of the plastic tube, which in particular can incorporate a shrink sleeve or a rubber sock, being able to prevent impurities from infiltrating into the connection between the first and second connecting section, whereby damage to the seal can be avoided. The plastic tube is thereby drawn over the first and second fluid-conducting line such that the plastic tube effectively encircles both the first and second connecting section as well as the retention collar.

In one advantageous example, the retention collar further comprises a plastic seal which is materially bonded to the retention collar, wherein the plastic seal in particular comprises a thermoplastic elastomer (TPE).

This example thereby achieves the technical advantage of the plastic seal materially bonded to the retention collar being able to provide a particularly effective fluidic sealing of the retention collar relative to an outer surface of the first connecting section or relative to an outer surface of the second connecting section respectively. A plastic seal materially bonded to the retention collar can in particular encompass a plastic seal molded onto the retention collar.

In one advantageous example, the first fluid-conducting line comprises a first line section of a first diameter, whereby the first connecting section exhibits a further first diameter, and whereby the further first diameter is larger than the first diameter.

This example thereby achieves the technical advantage of the radial expansion of the first connecting section relative to the first line section enabling the second connecting section to be inserted into the first connecting section via the further first diameter of the first connecting section, which is larger than the first diameter of the first line section, so as to provide an effective fluidic connection between the first fluid-conducting line and the second fluid-conducting line.

In one advantageous example, the second fluid-conducting line comprises a second line section of a second diameter, whereby the second connecting section exhibits a further second diameter, and whereby the further second diameter is in particular smaller than the second diameter.

This for example thereby achieves the technical advantage of the radial narrowing of the second connecting section relative to the second, line section enabling the second connecting section to be inserted into the first connecting section via the further second diameter of the second connecting section, which is in particular smaller than the second diameter of the second line section, so as to provide an effective fluidic connection between the first fluid-conducting line and the second fluid-conducting line. In so doing, the first diameter of the first line section can in particular correspond to the second diameter of the second line section, whereby a consistent diameter of the first and second fluid-conducting lines can be ensured at least within the area of the first and second line section. In order to enable effective insertion of the second connecting section into the first connecting section, the further second diameter of the second connecting section is in particular smaller than the further first diameter of the first connecting section.

In one advantageous example, the first connecting section comprises an internal stop, whereby a front end of the second connecting section inserted into the first connecting section abuts against the stop in order to limit the insertion of the second connecting section into the first connecting section.

This for example thereby achieves the technical advantage of the stop on the inner surface of the first connecting section limiting the insertion of the second connecting section into the first connecting section. The second connecting section can thereby only be inserted up to the point of the front end of said second connecting section abutting against the stop in the first connecting section. The second connecting section thus cannot be inserted into the first connecting section without limitation, whereby an effective fluidic connection can be ensured between the first fluid-conducting line and the second fluid-conducting line.

In one advantageous example, first locking pins are arranged on the first locking contour, second locking pins are arranged on the second locking contour, and the first and second locking pins are designed to prevent the radial rotation of the retention collar on the connecting apparatus.

This for example thereby achieves the technical advantage of the first and second locking pins preventing the retention collar from being able to rotate radially on the connecting apparatus. The first and second locking pins thereby in particular insert in each case between the first and second retaining projections and thus lock the position of the first and second retaining projections with respect to radial rotation of the retention collar.

In one advantageous example, the retention collar comprises a thermoplastic substance, in particular a polyamide, nylon, polyphenylene sulfide or mixtures thereof.

This for example thereby achieves the technical advantage of the use of a thermoplastic substance, in particular polyamide, nylon, polyphenylene sulfide or mixtures thereof, providing on the one hand for particularly advantageous manufacturability of the retention collar and, on the other hand, ensuring sufficient retention collar stability so as to prevent the retention collar from being damaged due to high temperatures and high pressures of the fluid being conveyed through the fluid conducting line.

According to a second aspect of the disclosure, the task is solved by a retention collar for a connecting apparatus in accordance with the first aspect, wherein the retention collar comprises first retaining projections designed to engage into a first locking contour on the outer surface of the first fluid-conducting line, and wherein the retention collar comprises second retaining projections designed to engage into a second locking contour on the outer surface of the second fluid-conducting line, wherein the first retaining projections engage into the first locking contour and wherein the second retaining projections engage into the second locking contour in order to limit an axial displacement of the first connecting section relative to the second connecting section.

This example thereby achieves the technical advantage of the retention collar ensuring a particularly effective fixing of the first and second connecting section.

### BRIEF DESCRIPTION OF THE DRAWINGS

Examples of the present disclosure are depicted in the drawings and will be described in greater detail below.

FIG. 1 shows an exploded view of a connecting apparatus for connecting fluid-conducting lines;

FIG. 2 shows a sectional representation of a connecting apparatus for connecting fluid-conducting lines in a first connecting position; and

FIG. 3 shows a sectional representation of a connecting apparatus for connecting fluid-conducting lines in a further connecting position.

### DETAILED DESCRIPTION OF THE DRAWINGS

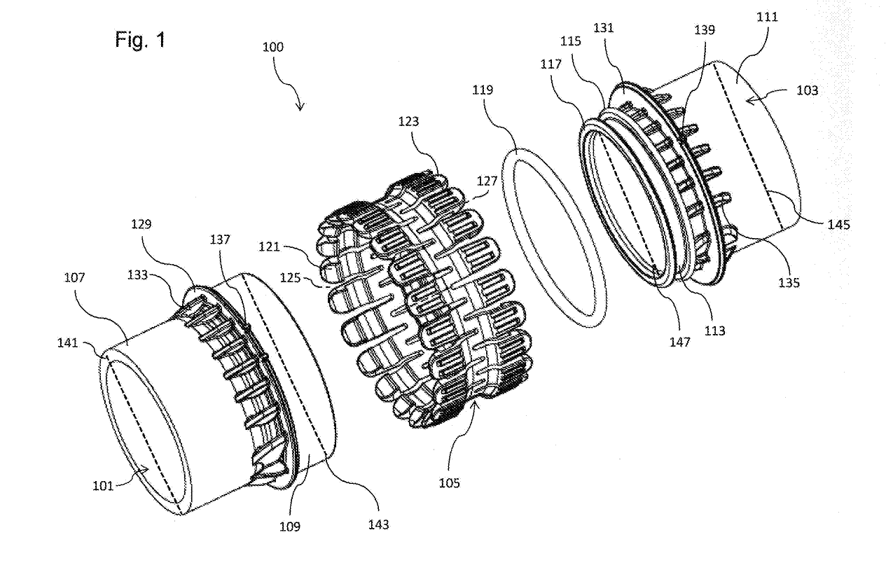

FIGS. 1, 2 and 3 show different views of a connecting apparatus for connecting fluid-conducting lines, wherein the fluid-conducting lines are in particular designed as lines for conducting air, e.g. in a motor vehicle.

FIG. 1 depicts a side view of a connecting apparatus for connecting fluid-conducting lines connected to a fluid line in an exploded view. The connecting apparatus 100 comprises a first fluid-conducting line 101, a second fluid-conducting line 103 and a retention collar 105. A fluid, in particular air, can be conveyed through the first and second fluid-conducting line 101, 103.

The first fluid-conducting line 101 comprises a first line section 107 and a first connecting section 109. The second fluid-conducting line 103 comprises a second line section 111 and a second connecting section 113. The second connecting section 113 thereby has an external circumferential sealing web 115 and a further circumferential sealing web 117, whereby a circumferential sealing ring 119 is arranged between the circumferential sealing web 115 and the further circumferential sealing web 117.

Not depicted in FIG. 1 is how a fluidic connection is provided between the first and second fluid-conducting line 101, 103 by the second connecting section 113 of the second fluid-conducting line 103 being axially inserted into the first connecting section 109 of the first fluid-conducting line 101.

The retention collar 105 fixes the first and second connecting section 109, 113 and comprises in particular a thermoplastic plastic, e.g. polyamide (PA), nylon, polyphenylene sulfide or mixtures thereof. The retention collar 105 is thereby designed as a circumferential retention collar 105 around the first and second fluid-conducting line 101, 103. The retention collar 105 has first retaining projections 121 and second retaining projections 123 arranged on opposite sides of the retaining projections 105.

Respective first slots 125 are arranged between the first retaining projections 121 and respective second slots 127 are arranged between the second retaining projections 123. The first retaining projections 121 are arranged at an offset relative to the second retaining projections 123. The first slots 125 are arranged at an offset to the second slots 127. The first slots 125 are arranged at the height of the second retaining projections 123 and the second slots 127 are arranged at the height of the first retaining projections 121. Plastic layers, in particular incorporating a thermoplastic elastomer (TPE), can thereby be arranged in the first and second slots 125, 127 to provide a fluidic sealing thereof.

A first locking contour 129 is provided on the outer surface of the first connecting section 109 of the first fluid-conducting line 101 into which the first retaining projections 121 can engage. A second locking contour 131 is provided on the outer surface of the second connecting section 113 of the second fluid-conducting line 103 into which the second retaining projections 123 can engage. The engaging of the first and second retaining projections 121, 123 into the respective first and second locking contours 129, 131 on different sides of the fluidic connection between the first and second fluid-conducting line 101, 103 can ensure that the retention collar 105 effectively fixes the connecting sections 109, 113 within the connecting apparatus 100. The connection between the first and second retaining projections 121, 123 and the first and second locking contours 129, 131 can encompass a form-fit or force-fit connection, in particular a latching connection. Doing so thereby prevents unintentional disengaging of the connection between the fluid-conducting lines 101, 103.

Since the fluid-conducting lines 101, 103, in particular charge air hoses, are often axially stretched or compressed in particularly constricted installation spaces within motor vehicles, or the fluid-conducting lines 101, 103 buckle at the connection between the fluid-conducting lines 101, 103 respectively, the retention collar 105 enables a certain flexibility to the fluid-conducting lines 101, 103.

The first retaining projections 121 thereby engage into the first locking contour 129 and the second retaining projections 123 engage into the second locking contour 131 in order to limit axial displacement of the first connecting section 109 relative to the second connecting section 113. The engaging of the retaining projections 121, 123 into the respective locking contours 129, 131 can thus prevent the second connecting section 113 of the second fluid-conducting line 103 from drawing out of the first connecting section 109 of the first fluid-conducting line 101 during operation. This can thereby prevent an unintentional disengaging of the connection between the fluid-conducting lines 101, 103.

If, however, the second connecting section 113 is fully inserted in the first connecting section 109 up to the stop, the retaining projections 121, 123 do not fully rest against the respective locking contours 129, 131. The second connecting section 113 can thus be axially displaced to a certain degree within the first connecting section 109 which affords increased flexibility to the connection between the first fluid-conducting line 101 and the second fluid-conducting line 103.

Furthermore, the circumferential sealing web 115 on the outer surface of the second connecting section 113 exhibits a rounded surface. When the second connecting section 113 is inserted into the first connecting section 109, the rounded surface rests against an inner surface of the first connecting section 109. Doing so can enable both fluid-conducting lines 101, 103 to be tilted within the connecting apparatus 100 up to an angle of approximately 5°, thereby ensuring a particularly advantageous flexibility to the connecting apparatus 100.

The first locking contour 129 is stabilized by first stabilizing props 133 on the first connecting section 109. The second locking contour 131 is stabilized by second stabilizing props 135 on the second connecting section 113. First locking pins 137 are arranged on the first locking contour 129 and second locking pins 139 are arranged on the second locking contour 131. The first locking pins 137 are received in the first slots 125 and the second locking pins 139 are received in the second slots 127 so as to prevent radial rotation of the retention collar 105.

The first line section 107 exhibits a first diameter 141 and the first connecting section 109 exhibits a further first diameter 143 which is larger than the first diameter 141. So that the second connecting section 113 can be effectively inserted into the first connecting section 109, the second line section 111 exhibits a second diameter 145 and the second connecting section 113 exhibits a further second diameter 147, wherein the further second diameter 147 is smaller than the further first diameter 143. The first diameter 141 hereby corresponds in particular to the second diameter 145 which can thereby ensure a consistent diameter 141, 145 to the first and second fluid-conducing line 101, 103 when connected together.

The connecting apparatus 100 can furthermore comprise a plastic tube, not shown in FIG. 1, which is drawn over the retention collar 105 connected to the first and second connecting section 109, 113. Doing so can prevent impurities from infiltrating into the retention collar 105 on the connecting apparatus 100.

The retention collar 105 can furthermore comprise a plastic seal which is materially bonded to the retention collar 105, wherein the plastic seal in particular comprises a thermoplastic elastomer (TPE) so as to provide effective sealing.

A significant constructional simplifying of the components employed and the facilitating of their fitting provides a particularly economical connecting apparatus 100. In addition, the retention collar 105 can be fastened to fluid-conducting lines 101, 103, consisting of a plurality of different materials, such that the retention collar 105 not only can be used with different motor vehicle charge air hoses from different manufacturers but is also suited to connecting a plurality of different fluid-conducting lines, this thereby ensuring the universal applicability of the retention collar 105. Moreover, a simplification of the constructional design of the retention collar 105 enables the connecting apparatus 100 to be individually adapted to the respective fluid-conducting lines to be connected in order to, for example, adapt to the permissible axial tolerance range of a particular installation space or to the temperatures of the fluid conducted within the fluid-conducting lines.

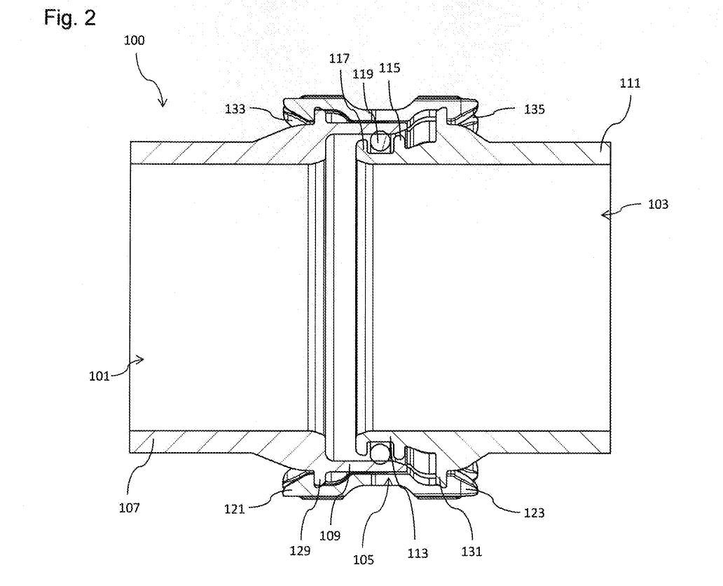

FIG. 2 depicts a sectional representation of a connecting apparatus for connecting fluid-conducting lines in a first connecting position. The connecting apparatus 100 comprises a first fluid-conducting line 101 having a first line section 107 and a first connecting section 109, whereby′ a first locking contour 129 is arranged on an outer surface of the first fluid-conducting line 101. The connecting apparatus 100 comprises a second fluid-conducting line 103 having a second line section 111 and a second connecting section 113, whereby a second locking contour 131 is arranged on an outer surface of the second fluid-conducting line 103. The second connecting section 113 is inserted axially into the first connecting section 109 in order to provide a fluidic connection between the first fluid-conducting line 101 and the second fluid-conducting line 103.

FIG. 2 further depicts first stabilizing props 133 for stabilizing the first locking contour 129 and second stabilizing props 135 for stabilizing the second locking contour 131.

The connecting apparatus 100 further comprises a retention collar 105 having first retaining projections 121 which engage into the first locking contour 129 and second retaining projections 123 which engage into the second locking contour 131 in order to limit axial displacement of the first connecting section 109 relative to the second connecting section 113. The engaging of the retaining projections 121, 123 into the respective locking contours 129 can thus prevent the second connecting section 113 of the second fluid-conducting line 103 from drawing out of the first connecting section 109 of the first fluid-conducting line 101 which thereby prevents the disengaging of the fluidic connection between the fluid-conducting lines 101, 103.

The second connecting section 113 exhibits an external circumferential sealing web 115 and a further circumferential sealing web 117, wherein a circumferential sealing ring 119 is arranged between the circumferential sealing web 115 and the further circumferential sealing web 117. The surface of the circumferential sealing ring 115 is rounded and rests against an inner surface of the first connecting section 109, enabling the fluid-conducting lines 101, 103 to tilt against each other.

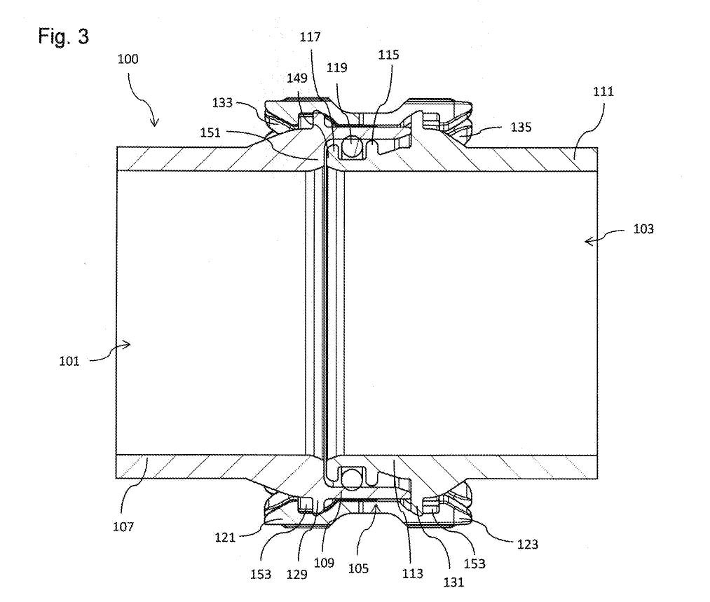

FIG. 3 depicts a sectional representation of a connecting apparatus for connecting fluid-conducting lines in a further connecting position. The connecting apparatus 100 comprises a first fluid-conducting line 101 having a first line section 107 and a first connecting section 109, whereby a first locking contour 129 is arranged on an outer surface of the first fluid-conducting line 101. The connecting apparatus 100 comprises a second fluid-conducting line 103 having a second line section 111 and a second connecting section 113, whereby a second locking contour 131 is arranged on an outer surface of the second fluid-conducting line 103.

In contrast to the representation depicted in FIG. 2, the second connecting section 113 in FIG. 3 is fully inserted axially into the first connecting section 109 in order to provide a fluidic connection between the first fluid-conducting line 101 and the second fluid-conducting line 103. A front end 149 of the second connecting section 113 thereby abuts against a stop 151 of the first connecting section 109 such that the second connecting section 113 cannot be axially inserted any farther into the first connecting section 109.

The second connecting section 113 exhibits an external circumferential sealing web 115 and a further circumferential sealing web 117, wherein a circumferential sealing ring 119 is arranged between the circumferential sealing web 115 and the further circumferential sealing web 117. The surface of the circumferential sealing ring 115 is rounded and rests against an inner surface of the first connecting section 109, enabling the fluid-conducting lines 101, 103 to tilt against each other.

Pushing the second connecting section 113 completely into the first connecting section 109 results in the first retaining projections 121 and the second retaining projections 121 of the retention collar 105 not resting fully against the first/second locking contour 129, 131. There is thus a respective limit gap 153 between the first retaining projections 121 and the first locking contour 129 as well as between the second retaining projections 123 and the second locking contour 131 in the further connecting position depicted in FIG. 3. The limit gap 153 ensures low axial displacement of the connecting sections 109, 113 against each other, which thereby ensures flexibility to the fluidic connection.

Since the second connecting section 113 is pushed completely into the first connecting section 109, a stable fluidic connection is provided between the first fluid-conducting line 101 and the second fluid-conducting line 103 without the retaining projections 121, 123 needing to abut against the respective locking contour 129, 131 in order to provide a stable connection between the two fluid-conducting lines 101, 103.

All of the features described and shown in connection with individual examples of the disclosure can be provided in different combinations in the inventive subject matter so as to realize their advantageous effects simultaneously.

The protective scope of the present disclosure is conferred by the claims and is not limited by the features defined in the description or illustrated in the figures.

### LIST OF REFERENCE NUMERALS

100 connecting apparatus
101 first fluid-conducting line
103 second fluid-conducting line
105 retention collar
107 first line section
109 first connecting section
111 second line section
113 second connecting section
115 circumferential sealing web
117 further circumferential sealing web
119 circumferential sealing ring
121 first retaining projections
123 second retaining projections
125 first slots
127 second slots
129 first locking contour
131 second locking contour
133 first stabilizing props
135 second stabilizing props
137 first locking pins
139 second locking pins
141 first diameter
143 further first diameter
145 second diameter
147 further second diameter
149 front end
151 stop
153 limit gap

What is claimed is:

1. A connecting apparatus for connecting fluid-conducting lines, comprising:
a first fluid-conducting line comprising a first connecting section;
a second fluid-conducting line comprising a second connecting section, wherein the second connecting section is introduced axially into the first connecting section to provide a fluidic connection between the first and the second fluid-conducting line; and
a retention collar for fixing the first and the second connecting sections to one another, wherein the retention collar comprises a first plurality of retaining projections configured to engage into a first locking contour on an outer surface of the first fluid-conducting line, and wherein the retention collar comprises a second plurality of retaining projections configured to engage into a second locking contour on an outer surface of the second fluid-conducting line;
wherein the first retaining projections engage into the first locking contour and wherein the second retaining projections engage into the second locking contour to limit an axial displacement of the first connecting section relative to the second connecting section.

2. The connecting apparatus according to claim 1, wherein the first and the second connecting sections are displaceably fixed by the retention collar.

3. The connecting apparatus according to claim 1, wherein the retention collar is configured as a circumferential retention collar around the first and the second fluid-conducting line, wherein the first plurality of retaining projections and the second plurality of retaining projections are arranged on opposite sides of the retention collar.

4. The connecting apparatus according to claim 1, wherein respective first slots are arranged between the first retaining projections, wherein respective second slots are arranged between the second retaining projections, wherein the first plurality of retaining projections are arranged at an offset relative to the second plurality of retaining projections, and wherein the first slots are arranged at an offset relative to the second slots.

5. The connecting apparatus according to claim 4, wherein plastic layers are arranged in the first and the second slots, wherein the plastic layers are configured to fluidically seal the slots vis-à-vis the outer surface of the first fluid-conducting line or the outer surface of the second fluid-conducting line.

6. The connecting apparatus according to claim 5, wherein the plastic layers in particular comprise a thermoplastic elastomer (TPE).

7. The connecting apparatus according to claim 1, wherein the connection between the first retaining projections and the first locking contour or the connection between the second retaining projections and the second locking contour is a positive-fit connection.

8. The connecting apparatus according to claim 7, wherein the positive-fit connection is a latching connection.

9. The connecting apparatus according to claim 1, wherein the second connecting section comprises an external circumferential sealing web, wherein the external circumferential sealing web is rounded on the side facing the first connecting section, and wherein the second connecting section comprises a further external circumferential sealing web, wherein a circumferential sealing ring around the second connecting section is arranged between the circumferential sealing web and the further circumferential sealing web.

10. The connecting apparatus according to claim 1, wherein the connecting apparatus further comprises a plastic tube that is drawn over the retention collar connected to the first and the second connecting section.

11. The connecting apparatus according to claim 1, wherein the retention collar further comprises a plastic seal which is materially bonded to the retention collar, wherein the plastic seal comprises a thermoplastic elastomer (TPE).

12. The connecting apparatus according to claim 1, wherein the first fluid-conducting line comprises a first line section of a first diameter, wherein the first connecting section exhibits a further first diameter, and wherein the further first diameter is larger than the first diameter.

13. The connecting apparatus according to claim 1, wherein the second fluid-conducting line comprises a second line section of a second diameter, wherein the second connecting section exhibits a further second diameter, wherein the further second diameter is smaller than the second diameter.

14. The connecting apparatus according to claim 1, wherein the first connecting section comprises an internal stop, wherein a front end of the second connecting section inserted into the first connecting section abuts against the stop to limit the insertion of the second connecting section into the first connecting section.

15. The connecting apparatus according to claim 1, wherein first locking pins are arranged on the first locking contour, wherein second locking pins are arranged on the second locking contour, and wherein the first and second locking pins are configured to prevent a radial rotation of the retention collar on the connecting apparatus.

16. The connecting apparatus according to claim 1, wherein the retention collar comprises a thermoplastic substance.

17. The connecting apparatus according to claim 16, wherein the thermoplastic substance is a polyamide, nylon, polyphenylene sulfide, or some combination thereof.

18. A retention collar for a connecting apparatus, wherein the retention collar comprises:
a first plurality of retaining projections configured to engage into a first locking contour on an outer surface of a first fluid-conducting line; and
a second plurality of retaining projections configured to engage into a second locking contour on an outer surface of a second fluid-conducting line, wherein the first retaining projections engage into the first locking contour and the second retaining projections engage into the second locking contour to limit an axial displacement of the first connecting section relative to the second connecting section.

19. The retention collar according to claim 18, herein the retention collar is configured as a circumferential retention collar around the first and the second fluid-conducting line, wherein the first plurality of retaining projections and the second plurality of retaining projections are arranged on opposite sides of the retention collar.

20. The retention collar according to claim 18, wherein plastic layers are arranged in the first and the second slots, wherein the plastic layers are configured to fluidically seal the slots vis-à-vis the outer surface of the first fluid-conducting line or the outer surface of the second fluid-conducting line.
